(19) United States
(12) Patent Application Publication
(10) Pub. No.: US 2012/0303464 A1
(43) Pub. Date: Nov. 29, 2012

(54) UNIFIED YIELD MANAGEMENT FOR DISPLAY ADVERTISING

(75) Inventors: Robert Paul Gorman, Woodinville, WA (US); Pavel Berkhin, Sunnyvale, CA (US); Nikhil Devanur Rangarajan, Bellevue, WA (US); Marc Diamond, Renton, WA (US); Peng Han, Issaquah, WA (US); Bashar Kachachi, Kirkland, WA (US); Muthukrishnan Paramasivam, Seattle, WA (US); John A. Beaver, Kirkland, WA (US); David G. Heindel, Redmond, WA (US); Izzet Can Envarli, Kirkland, WA (US); Ye Chen, Sunnyvale, CA (US)

(73) Assignee: MICROSOFT CORPORATION, Redmond, WA (US)

(21) Appl. No.: 13/116,949

(22) Filed: May 26, 2011

(51) Int. Cl. G06Q 30/00

(52) U.S. Cl. 705/14.71

(57) ABSTRACT

Systems and method can be provided for selecting advertising payloads for display in an available advertising impression location. The advertising payloads can be selected based on an auction between various types of hosted and third party campaigns, including hosted reserved advertising campaigns and hosted non-reserved advertising campaigns. The rules of the auction can be set and/or updated over time to allow hosted campaigns to meet desired goals, such as delivering a minimum number of impressions or spending an expect budget amount.

### BACKGROUND

Online advertising can be an important piece of the marketing campaigns and sales strategies of many client businesses, advertisers, or content providers. In order to accommodate advertisers wishing to post online advertisements, web pages are often designed to offer content regions therein for sale. These content regions can be configured to present advertisements to the end user upon navigating to the web pages. However, these advertisements may be presented only if the advertisers place orders to purchase a particular number of display instances, or impressions. A delivery engine can be responsible for accepting the orders and distributing the advertisements for presentation at the content regions of selected web pages.

One type of advertising campaign order that can be received is an order for a guarantee of delivery of a number of impressions. This can sometimes be referred to as a reserved advertising campaign. A reserved campaign order can be guaranteed upon acceptance of the order. That is, the delivery engine can make a commitment to show the number of impressions as instructed in the order. For instance, if an advertiser places an order for one million impressions of a particular advisement, acceptance of the order by a delivery engine corresponds to an agreement that the delivery engine will cause each of the one million impressions to occur. If the delivery engine does not meet its obligation to present each of the one million impressions of the advertisement, or underdelivers, the advertisers may experience customer dissatisfaction which may result in the delivery engine losing business or being forced to offer rebates to retain their current business. This problem of fulfilling the orders accepted by the delivery engine can be exaggerated in the situation where the delivery engine is servicing multitudes of advertisers that each place various orders with different time frames for presenting impressions of the advertisements being ordered.

Conventional mechanisms for ascertaining how to deliver ordered impressions of advertisements and for determining whether inventory is available for accepting new orders can be labor-intensive (e.g., requiring a considerable amount of user-initiated tracking and calculations) and are not fluid, flexible, or efficient. Further, these conventional mechanisms are ad-hoc solutions that cannot dynamically react to a change in orders or inventory.

Although reserved campaigns can be purchased, a portion of the available impressions may be available after the requirements of all reserved campaigns are satisfied. This remnant of additional impressions can be fulfilled by selling the additional impressions in a non-guaranteed fashion, such as on an as-needed basis. This additional as-needed advertising can supplement the income of the owner of the available impressions.

### SUMMARY

In various embodiments, systems and method can be provided for selecting advertising payloads for display in an available advertising impression location. The advertising payloads can be selected based on an auction between various types of hosted and third party campaigns, including hosted reserved advertising campaigns and hosted non-reserved advertising campaigns. The rules of the auction can be set and/or updated over time to allow hosted campaigns to meet desired goals, such as delivering a minimum number of impressions or spending an expect budget amount.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIGS. 1a-1c schematically shows an example of an auction process according to an embodiment of the invention.

FIG. 2 is a block diagram of an exemplary computing environment suitable for use in implementing embodiments of the present invention.

FIG. 3 schematically shows a system environment suitable for performing embodiments of the invention.

FIG. 4 schematically shows another system environment suitable for performing embodiments of the invention.

FIG. 5-6 show examples of methods according to various embodiments of the invention.

### DETAILED DESCRIPTION

### Overview

In various embodiments, systems and methods are provided for allowing competition for advertising impressions between reserved (or guaranteed) advertising campaigns and non-reserved campaigns. In a conventional advertising engine, the impressions for guaranteed campaigns can be assigned first, so that as-needed advertising is only accessed after requirements for reserve campaigns are satisfied. While this ensures fulfillment of a reserved campaign, this can potentially lead to lost revenue due to a reserved campaign using advertising impressions that could command a higher value. By allowing reserved and non-reserved campaigns to compete, the revenue generated by impressions can be enhanced or optimized while still satisfying the guarantees required by the guaranteed campaign.

### Reserved, Non-Reserved, and Hosted Campaigns

In various embodiments, a publisher with an available ad impression that needs to be filled can sell the impression as either part of a reserved campaign or as non-reserved advertising. An impression can correspond to an available location on a page being delivered by a publisher where advertising can be displayed. Typically, the page is delivered to a user via a browser. An advertiser can provide a payload to the publisher for display in the impression location. This payload can be provided to the publisher in advance, or the payload can be delivered near the time when the impression becomes available.

A reserved campaign refers to an order for display of advertising impressions, with some type of minimum constraint on the number of impressions that will be provided. A reserved campaign can be hosted by the publisher. The number of impressions corresponding to the minimum constraint can be referred to as a delivery guarantee. If the minimum number of impressions are not delivered, then the publisher may be required to pay a penalty to the advertiser. It is noted that a maximum constraint may also be applied, and in the limiting case the minimum constraint and maximum constraint can have the same value, corresponding to a guarantee to deliver a fixed number of advertising impressions. In this situation, a penalty could be imposed for either underdelivery or overdelivery, with the overdelivery penalty possibly corresponding to the publisher receiving no additional payment for overdelivery. One or more other constraints can also be placed on the type of impression used for display of the advertising, such as constraints related to the content of the corresponding web page, the user viewing the browser, or a time related constraint. Typically, for a reserved campaign the advertiser can provide the payloads (advertisements for display) to the publisher in advance. When a publisher identifies an impression that matches the constraints for a reserved ad campaign, the payload corresponding to the campaign can be retrieved and displayed in the identified impression location. Alternatively, if an advertiser has a suitable on-line capability, the payload can be retrieved by the publisher from the on-line capability as needed for insertion as an advertising impression.

A non-reserved advertising campaign can refer to an order for advertising impressions that does not include a guarantee of a minimum number of impressions. Instead, a non-reserved advertising campaign can compete for available impressions based on price. Non-reserved campaigns can also specify constraints regarding the content of the web page containing the impression, the characteristics of the user, or other constraints. A non-reserved campaign can represent a campaign hosted by a publisher. In this situation, the publisher can acquire the advertiser's materials in advance and serve the advertisements when suitable impressions become available. Alternatively, a non-reserved campaign can correspond to advertising that a publisher receives by offering an impression on a spot market for advertising. This can allow any advertiser to compete for the impression based on price, regardless of whether the publisher has a prior relationship with the advertising entity.

Conventionally, a simple way to allocate advertising for reserved campaigns relative to non-reserved campaigns can be to simply allocate all advertising for reserved campaigns first. Under this conventional method, impressions can be made available to non-reserved campaigns only after all demands from reserved campaigns have been satisfied. While this method of allocation can facilitate meeting the guarantee goals of reserved campaigns, this allocation method may not provide the best match of advertising with available impressions with regard to revenue. In particular, a non-reserved campaign may be willing pay more for a high value impression than a reserved campaign. Thus, it can be desirable to balance the goal of delivering reserved advertising impressions with the goal of increasing revenue derived from each impression.

### Baseline Bid Values and Impression Values

In order to allow competition between campaigns, such as by holding an auction, a bid can be associated with each advertising campaign. A baseline bid value for both reserved and non-reserved campaigns can be set in any convenient manner. For example, a baseline bid for a reserved campaign can correspond to the amount paid for the campaign divided by the number of guaranteed impressions. This can yield an amount paid per impression. An average expected cost per impression can also be used to generate a baseline bid for a non-reserved campaign. When an impression becomes available, the constraints of various campaigns can be compared with the profile for the impression, such as the content of the page containing the impression and/or the user viewing the page. Campaigns with constraints that match the impression profile can submit bids in order to “win” the impression. A campaign that wins an auction for an impression can have the payload corresponding to the campaign displayed in the impression location. In a simple auction, the amount per impression values for each advertising campaign interested in an impression could be compared, with the highest bid being awarded the impression.

While a cost per impression is one method for determining a bid, some advertising campaigns can be budgeted based on a click-through-rate for delivered impressions. In other words, some advertisements may only pay a publisher based on a user clicking on and/or performing an action after clicking on an advertisement. If the user does not interact sufficiently with an advertisement, the advertiser does not pay the publisher. In an embodiment where baseline bids are generated based on a cost per impression, advertisement campaigns can modify baseline bids based on the expected click through rate of a user. The expected click through rate can be based on the nature of the available impression, the nature of the user receiving or viewing the impression, or a combination thereof. Additionally or alternately, the baseline bid can be modified based on a likelihood that a user will interact with an advertisement in a specified manner, such as viewing the advertisement for at least a minimum time. This can represent a user performing an action after clicking on an advertisement. This type of modified baseline bid can provide a better representation of the value of an impression for a non-reserved campaign.

In addition to a click through rate, other factors can be used to modify the baseline bid value. These factors can be used to represent that an impression is more valuable (or less valuable) than a typical impression. For example, a plurality of different types of sports-related web pages may have an available impression. Although the various web pages all have sports content, the corresponding impressions can have different values. One web page may have users that typically correspond to a desired advertising demographic. The characteristics of a user viewing a web page can alter the value of an impression for an advertiser. Another web page may correspond to a web site where past usage data (such as user surveys) indicates that users pay less attention than average to advertising on the page. Still another web page may have specialized content that places the page in a separate category or node of pages. The web pages belonging to the separate category or node can be more (or less) valuable to advertisers due to the nature of the web page content. Yet another web page may have an available impression, but the location of the impression on the page is known to be less favorable based on general statistics across various types of pages. Still another web page may simply be a web page that is desired by one or more advertisers, and therefore the one or more advertisers will pay more for impressions on such pages. More generally, any other type of data related to the web page content, the characteristics of the user, or the interaction of users with the type of impression can be used to modify a baseline bid value.

A value can also be associated with an available impression. For available impressions, a default value for an impression can be generated in any convenient manner. A default value can be assigned to all impressions generally, or to all impressions on pages of a certain type or containing a certain content. Other methods can also be used to generate an initial default value. The default value for an impression can then be modified by any of the factors described above in relation to modifying baseline bid values. Optionally, when an auction is conducted, the value of an impression can be made available to the participants in the auction, so that bids can be modified to reflect the value of the impression.

Assigning Demand from Hosted Campaigns to Predicted Available Impressions

Due to the nature of how users view web pages over a network, it is difficult to know in advance the exact type and amount of impressions that will become available over the course of a time period. However, estimates of expected or predicted inventory can be made based on past usage patterns. Simple usage estimates can be based on a total expected number of impressions. More detailed estimates can involve expected content associated with predicted impressions, expected user characteristics associated with predicted impressions, or a combination thereof. For more detailed estimates, expected impressions can be associated as groups of impressions. The groups of impressions can correspond to impressions from similar types of pages, or impressions from pages with similar content, or pages viewed by similar users, or any other type of convenient grouping.

Based on the prediction of inventory that will be available, hosted demand can be assigned to the predicted inventory. This prediction can be performed based on the type of inventory that is predicted to be available. As the model for the types of predicted inventory becomes more detailed, the hosted demand can be assigned with more specificity. Typically, the detail available for the inventory prediction can match the level of detail available corresponding to characteristics of the demand. Thus, if the demand (advertising) can specify a type of web page content and user characteristics, the predicted inventory can be in the form of groups or lines of inventory that can have similar a similar specification or granularity of features.

Based on the hosted demand and the predicted inventory, any convenient method can be used to assign demand to inventory. One option for assigning demand to inventory can be to use one or more linear programs to allocate the demand based on one or more constraints. For reserved campaigns, the minimum delivery constraint can provide a natural constraint for allocating demand. An example of a second constraint can be to provide smooth delivery of advertisements over the course of a campaign. A third possible constraint can be to maximize revenue over all campaigns. For a reserved campaign, although each impression can count as a single impression for purposes of determining underdelivery, the value of the impressions can still be accounted for. One method for accounting for impression value can be based on how impressions are grouped when assigning the impressions to inventory.

Non-reserved demand hosted by a publisher typically does not have a minimum delivery constraint associated with the advertising campaign. However, the campaign typically can have an expected budget. In some embodiments, a publisher can increase overall revenue by allowing non-reserved hosted campaigns to spend the expected budget. Thus, one option for employing linear programs to allocate the non-reserved demand can be to treat the expected budget in the same manner as a minimum delivery constraint. For a reserved campaign, each impression delivered to a user can count as one unit of delivered impressions. A corresponding scheme can be set up with regard to the expected budget for a non-reserved campaign. For a non-reserved campaign, each impression may not count as “1” budget impression. Instead, the value of delivery of an impression can be dependent on the value of the impression, such as a default value modified by an expected click through rate and/or action rate for the impression. The expected click through rate or action rate can be based on the type of content, the expected user viewing the content, or any other convenient factor.

As an example, consider a situation where a plurality of orders (reserved or non-reserved) have been received by a publisher. Each of these orders corresponds to a request to place advertisements. Each individual order can be referred to as an order j from the group of all orders J being handled by the publisher. An order j can be a request to have advertising payloads placed in one or more matching advertising impressions in available impression locations i selected from an inventory I of available impressions. The available impressions i can be matched based on a profile of the impression as compared to the profile of the advertising campaign. Matching impressions i can be considered to be part of an inventory subset Iⱼ. For example, a campaign can request display of an advertising payload in an available impression on a web page related to sports or weather when the viewing user is male. Only impressions having a matching profile can qualify as impressions i from the total available impressions I. The available impressions i can be impressions available during a time period T requested by the advertising campaign.

Using these definitions, the total demand x for advertising impressions for a campaign j can be expressed as xⱼ⁰. To satisfy this demand, individual advertising impressions xᵢⱼ can be assigned to campaign j. The values for xₜᵢⱼ can be constrained so that xₜᵢⱼ=0 for any impression where time t is outside of the requested time period T for a campaign j, and xₜᵢⱼ=0 for any impression i where i is not a member of Iⱼ. Additionally, for each campaign j, the sum of the xₜᵢⱼ values can be constrained to be less than the total impression demand xⱼ⁰. Also, over all campaigns J, the sum of the xₜᵢⱼ values can be constrained to be less than the total number of available impressions yₜᵢ (the supply of impressions) during the time period T.

Based on the above supply and demand example, a linear program can be executed to allocate impressions based on a balance of revenue, underdelivery, and smooth delivery considerations. The overall goal can be to maximize an objective function

H=H₀−E₁−λ₂E₂

Each portion of the objective function H can be further defined. The first term H₀ can be a revenue portion of the function. The revenue H₀ can be calculated based on the revenue from each campaign j based on expected impressions i allocated to the campaign at a time t during the time period T for the campaign. Based on an expected price pⱼ⁰ for a campaign, the revenue can be mathematically expressed as

H_{c}=Σ_{jεJ}pⱼ⁰xⱼ, xⱼ=Σₜᵢxₜᵢⱼ

The second term E₁ can correspond to an underdelivery penalty for the objective function. For a campaign that has a minimum delivery requirement xⱼ⁰, any impressions requested but not delivered can correspond to an underdelivery μⱼ. Any underdelivery of a campaign can have an associated penalty value pⱼ¹. The underdelivery penalty can be expressed mathematically as

E₁=Σ_{jεJ}pⱼⁱμⱼ, μⱼ=xⱼ⁰−xⱼ

For just the H₀ term, the revenue can be increased by assigning impressions to campaigns with higher values of expected price pⱼ⁰. However, a campaign with a lower expected value pⱼ⁰ could have a higher value pⱼ¹. Thus, maximizing the object function H does not necessarily correspond to assigning impressions to campaigns with the highest price per impression.

The third term in the objective function H corresponds to a penalty for delivery that is not sufficiently “smooth”. Smooth delivery refers to assigning matching impressions to a campaign at a relatively consistent rate during the course of the campaign. For example, if a campaign requests 1000 advertising impressions over the course of a week, it may not be desirable to deliver no impressions during the first six days and then deliver all 1000 advertisements on the final day.

The value of smooth delivery can vary relative to the revenue and underdelivery values. The relative value for smooth delivery can be controlled by several parameters. First the value λ₂ provides a weighting for the smooth delivery term across all campaigns. This can be used to provide a general relative weighting between smooth delivery and other terms in the objective function. The λ₂ value can also be used to adjust the objective function, for example, if a known period of disruption of impressions is about to occur. For example, it may be known that available impressions on the Thursday of Thanksgiving in the United States are particularly valuable and/or that there are a particularly large number of available impressions. For time periods involving such a time period, it may be useful to reduce the value of λ₂ so that the objective function does not receive a penalty for stacking valuable advertising in the high value time period.

In addition to the general weighting factor λ₂, each campaign can also have a smooth delivery weighting factor bⱼ⁰. This can reflect the relative importance of smooth delivery to an individual campaign. This relative importance can be based on the terms of the advertising campaign, an importance of the customer for the publisher, or any other convenient factor.

In order to evaluate E₂, a variety of penalty functions E_{SM} having various shapes can be used. One example can be to have a penalty function with no penalty for small deviation and a larger, constant penalty for any deviation beyond the desired amount. Another can have no penalty for small deviation and a penalty that scales linearly with the amount of deviation for deviation amounts beyond a threshold value. Still other functional formats and combinations of threshold values can be used to generate a desired shape for the E_{SM} penalty function.

The amount of deviation from smooth delivery can be determined based on an expected amount of delivery versus an allocated amount. One option for an expected delivery amount can be to have all delivery be proportional to the amount of time in a time segment. In this option, a seven day ad campaign can expect to delivery 1/7 of the advertisements during each day of the campaign. Alternatively, an advertiser could provide an expected delivery rate for various time periods during the course of a campaign. In this discussion, the proportional delivery rate option will be used in order to simplify the example. The expected amount of impressions for a campaign during a time period can then be compared with the allocated amount for the campaign. Optionally, this can be further weighted to account for size of a campaign. For example, a campaign with an average amount of only 100 impressions per day can be more sensitive to the shift of a few impressions to different days as compared to a campaign with an average delivery of 1000 advertisements per day. Mathematically, the smoothness penalty can be represented as

E₂=Σ_{jεJ}bⱼ⁰Σ_{tεT}_{ⱼ}E_{SM}(expected−allocated)

As an example, a first linear program can be executed to ascertain whether underdelivery of the currently booked orders may occur, either for reserved campaign orders or non-reserved campaign orders. If sufficient inventory is available to avoid underdelivery for a given campaign, the allocation from the linear program can be used to determine the amount of excess inventory of a given particular type. An expected win rate for a campaign for a given type of inventory can also be calculated.

The first linear program can include a term that attempts to minimize a risk of underdelivery. The first object function can be configured to allocate impressions to orders that are booked in the system. If conditions arise (e.g., given a lowered capacity forecast) that prevent all orders from being delivered, the first object function can prefer to under deliver on low-valued order lines rather than on high-valued order lines. Accordingly, the first linear program can attempt to minimize the underdelivery cost.

Objective functions of the above type can also be modified to reflect a blending of goals. In the above function H, the underdelivery goal was represented as a constraint to deliver a number of impressions xⱼ⁰ for each campaign j. However, a non-reserved campaign may not have a desired number of impressions for delivery. Instead, a non-reserved campaign may have an expected budget. In this situation, instead of a uⱼ value that represents underdelivery, a qⱼ value can be used that represents underspend of the expected budget. In an underspend formulation, each impression delivered for a non-reserved campaign can reduce the qⱼ value by a variable amount, based on the monetary value of the impression, as opposed to having each impression count as 1 delivered impression for the underdelivery constraint. The qⱼ values can thus represent the amount of budget not utilized. Optionally, if it is desirable to modify the weighting of underspend relative to weighting for underdelivery, the qⱼ values can be further modified by a weighting constant. This can allow the same overall functional format to be retained. By using the same functional format, a single function can be used to represent both underdelivery and underspend by incorporating a geometric average into the functional form. For example, a term pⱼ¹xⱼ can be replaced by (pⱼ¹xⱼ)^{γ}(pⱼ¹qⱼ)^{1-γ}. In the limiting cases where γ is 0 or 1, the term can correspond to pure underdelivery or pure underspend, respectively.

As noted above, the sum of the xₜᵢⱼ values can be constrained to be less than the total impression demand xⱼ⁰. This constraint can ensure that the delivery engine will not over-deliver the booked orders. In other words, this constraint can ensure that no bonus is awarded for showing more impressions than were ordered by, or promised to, the advertiser, as no credit for over-delivering is typically given. Similarly, for the corresponding constraint qⱼ related to expected budget, no credit is given for exceeding the expected budget.

In addition, minimizing an object function of a first linear program subject constraint(s) may include minimizing the object function subject to a constraint

$${∀}_{i , j , t} {x}_{ijt} \leq {y}_{it} p ( {U}_{j} ) - {\sum }_{k \neq j . t . {R}_{k} \geq {R}_{j}} {x}_{ikt} p 〈 {U}_{j} \vert {U}_{k} 〉$$

of the linear program. In operation, the third constraint ensures that the delivery engine cannot deliver, or allocate, more impressions than are estimated to be available per a time frame. In embodiments, the impressions that are estimated to be available can be based on a predicted number of user visits within a particular placement criteria. In addition to the subject matter of a page offering an impression, the third constraint can consider customers that are specifying demographics and/or can be cognizant of the people's characteristics that are actually visiting a web page. For instance, the third constraint can look at 100 impressions available within the context or node football and see that only 30 impressions are generated by female visitors.

Generally, the first term yᵢₜp(Uⱼ) represents the estimated inventory of impressions available that meet the placement criteria. That is, the first term represents a number of impressions available for order line j for node i at time t, assuming no other orders are in the delivery engine. In particular, yᵢₜ represents the total number of impressions that are expected to occur at a content node i within a segment of time t (e.g., 100 impressions per day at football web pages). pUj represents the probability that an impression at node i will match the targets Uj. Accordingly, the first term finds the total number of impressions available during the time period t targeting the leaf node yᵢₜ. Of these impressions, a fraction p(Uⱼ) will actually match the targeting criteria or profile for an order j. A similar factor p(Qⱼ) can be used for the budget constraint version of the linear program.

The second term

$${\sum }_{k \neq j . t . {R}_{k} \geq {R}_{j}} {x}_{ikt} p 〈 {U}_{j} \vert {U}_{k} 〉$$

represents a portion of the estimated inventory of impressions that is ostensibly allocated to the booked orders submitted by customers that have a priority level which ranks higher or equal to a priority level assigned to an advertiser submitting the candidate order. In particular, the second term represents inventory that is subtracted away from the total available to order j due to the delivery engine serving impressions to orders of higher priority. In particular, for each competing order k with higher priority, the total number of impressions served to order k during the time segment t is xᵢₖₜ. The impressions that could have been delivered to order j and are not available due to order line k are represented by p(Uⱼ|Uₖ). The ratio represents an overlap in inventory volume that the customers and content provider compete for (e.g., percent of available volume per day is in competition with the candidate order). The variable p represents an overlap in targeted space. If disjoint (e.g., one customer targets male and a competitor targets female) then P=0.

Stated another way, the second term operates to subtract the impressions from candidate order that are directly competing against the advertiser submitting the candidate orders. However, only those impressions associated with competing customers of a higher priority are subtracted. As one type of example, priority can be based on how specific the profile criteria is for an advertiser. In this type of embodiment, if advertiser 1 is targeting males while advertiser 2 is targeting males over 18, advertiser 2 can be granted higher priority because their placement criteria is more specific and the impressions within the inventory are more rare, thus, harder to find. Additionally or alternately, priority can be set based on any other factors associated with an advertising campaign, including based on an advertiser paying for the right to have a higher priority.

### Using a Dual of a Linear Program to Determine Baseline Prices

In some embodiments, additional information can be extracted from linear programs related to baseline bids for various campaigns in an auction. This additional information can be extracted by using the “dual” of the linear program for allocating inventory.

A dual of a linear program refers to a program with a specific relationship to the first linear program. In order to provide an example, we can consider a simpler object function H that only includes the H₀ revenue term and the E₁ underdelivery term. This object function can be recast so that rather than receiving a penalty for non-delivered impressions, a positive value for avoiding the penalty is gained for each delivered impression. This provides a function to maximize of

H=Σ_{jεH}(νⱼ)xᵢ

This function is subject to the constraints that the campaign is not overdelivered (impressions assigned to the campaign are less than xⱼ⁰); that the number of impressions of a given type assigned to the campaign is less than the number of available impressions of that type; and that there are no “negative” impressions (xᵢⱼ>0). The vⱼ value can be, for example, (pⱼ⁰+pⱼ¹) from the above discussion. For this type of function, a dual function can be minimized. The dual function can be expressed as

Σ_{jεJ}αⱼxⱼ⁰+Σₜzᵢ, subject to ∀i,j,αⱼ+z₁≧(vⱼ)

In the above equation, αⱼ and zᵢ are greater than or equal to 0. A solution for the αⱼ values that allows the original object function to be maximized and that also minimizes the dual function will provide a value zᵢ=(vⱼ−αⱼ) that corresponds to a baseline price that should be bid by campaign j for an impression i. This solution for zᵢ also corresponds to a maximum value for (vⱼ−αⱼ). From a practical standpoint, the αⱼ values can be thought of as a discount value that causes a campaign j to bid the correct amount to win the right number of impressions based on the allocation of predicted inventory.

As a variation on the dual function, it is noted that the j that results in a maximum for (vⱼ−αⱼ) may not be unique. To account for this, a matrix of small values vᵢⱼ^{small} can be generated randomly for each i,j pair. This should eliminate any potential “ties” by changing (vⱼ−αⱼ) to (vⱼ+vᵢⱼ^{small}−αⱼ).

Win Rates, Wins over Time, and Average Win Value

One way of increasing revenue derived from impressions can be to allow some competition between reserved campaigns and non-reserved campaigns. This competition can be handled as a type of auction involving one or more advertising campaigns. Based on the allocation of demand to expected inventory, a number of values can be calculated to determine a basis for conducting an auction. First, an amount of expected inventory relative to each campaign can be determined. If the amount of expected inventory is less than the amount required for a reserved campaign, it may not be beneficial to auction that inventory, as there is already a substantial risk of underdelivery for the reserved campaign. In another scenario, the amount of inventory of certain types may be sufficient to satisfy reserved campaign demand, but insufficient to satisfy demand from non-reserved hosted campaigns. In this situation, it may be beneficial to allow auctions to occur between reserved campaigns and hosted non-reserved campaigns, but to exclude third party campaigns. Still another possibility can be that excess inventory is available after filling all hosted demand. In this type of situation, it may be desirable to allow competition between hosted campaigns (reserved and non-reserved) and third party campaigns. Yet another option can be to partition inventory so that reserved demand is automatically assigned to a portion of the inventory, while other portions of the inventory are assigned by an auction process.

As part of determining how much inventory can be assigned by an auction process, an expected win rate for various campaigns can be determined. For example, if reserved campaigns need 50% of the expected impressions of a type of inventory in order to meet reserved demand, then a net win rate of 50% can be expected. The net win rate of 50% can be set by requiring assignment of 50% of expected impressions to reserved campaigns. Another option can be to have all inventory at auction, and try to set other factors so that the reserved campaigns win 50% of impressions. Still another option can be to assign some inventory for reserved campaigns and allow competition for the remaining inventory, so that the reserved campaigns need to win less than 50% of the remaining auctioned inventory.

In addition to a win rate, an amount of impressions to win per time period can also be determined from the assignment of the expected inventory. Even if the win rate for a campaign is correct, if the actual inventory deviates from the expected inventory, the amount of impressions assigned to a campaign may correspond to underdelivery or overdelivery. If wins per time period is indicating an underdelivery or overdelivery condition, it can be beneficial to allow the win rate to deviate from the expected win rate.

Still another factor that can be tracked is the value of impressions that a campaign is winning. As noted above, impressions can have different values for a variety of reasons. As impressions become available, an associated value can be determined for an impression. For example, all impressions can start with a default value, and then the default value can be modified by a variety of factors. The modification factors can include the characteristics of the user viewing the impression, the nature of the content on the page containing the impression, the location or other features about the impression on the page, or other factors.

One method for tracking the value of impressions being won by a campaign can be to track the value of impressions relative to the value of the expected impressions that were assigned to the campaign by the linear programs. A second way of tracking the value can be to compare the value of impressions won by a campaign with the average value for all impressions that a campaign competes for. The impressions that a campaign competes for can include impressions that a campaign automatically wins under auction rules. Comparing the value of impressions won by a campaign with the average value of all impressions the campaign competed for can provide insight into whether the impressions won by a campaign are representative.

### Auction Rules, Bids, and Bid Bias

Based on the above inputs, auction rules can be associated with various types of impression inventory. As an initial step for allowing an auction, a determination can be made regarding the types of campaigns, or bid sources, that can participate in an auction for a given impression. This can be used for selection of auction rules related to bid sources that will participate in an auction. As noted above, if there is insufficient inventory, an auction may not be desirable. In this situation, an auction rule can be set up that indicates assignment of an impression to a reserved campaign without having an auction. Alternatively, an auction can be conducted to gather information, but the reserved campaign can be declared the winner regardless of the bid values. In other situations, the number of bid sources that are allowed to compete for an impression can be expanded, such as by having a combination of automatic wins for reserved campaigns with various amounts of auction competition. The bid sources allowed to compete in an auction can be a subset of the available types of campaigns, such as allowing hosted non-reserved bid sources to participate but not allowing third party bid sources to participate.

In this discussion, various types of bid sources are discussed. Example bid sources can include reserved bid sources, hosted non-reserved bid sources, and third party bid sources. Each bid source can represent a plurality of advertising campaigns of the bid source type. For convenience, the discussion may refer to having only one bid source of each type of campaign. This can reflect that for each type of bid source, an internal competition or selection can be held so that a bid source only generates a bid from one campaign associated with a bid source. However, in some embodiments, more than one bid source may be available of the same general type. For example, a publisher may have more than one mechanism for acquiring hosted non-reserved campaigns. These separate mechanisms can act as separate hosted non-reserved bid sources with regard to bidding in an auction. In this situation, the multiple hosted non-reserved bid sources can potentially each generate a bid in an auction. In this discussion, each separate source can potentially be included or excluded separately from an auction. Similarly, a separate bid bias value can potentially be applied to each distinct source, even though more than one source may generically represent reserved content, hosted non-reserved content, or third party non-reserved content.

Once auctions are allowed, a simple highest bidder auction could lead to under-delivery (or over-delivery) of advertisements corresponding to one or more reserved campaigns relative to expected win rates and/or wins over time. In order to achieve desired win rates and/or wins over time, an auction can be conducted with modified auction values. One type of modification can be a modification to the baseline bid value for a reserved campaign. For example, because a reserved campaign can correspond to advertising purchased in advance, the reserved campaign price may represent a discount relative to a standard rate, to reflect the advance nature of the agreement. To account for this, the baseline bid can be increased to remove the discount from the bid price. Other options for modifying the baseline bid can result in higher (or lower) baseline bids for a reserved campaign.

Another option for modifying the nature of an auction can be to use bid bias values. Bid bias values can modify the competitiveness of various types of advertising campaigns relative to each other. A bid bias value could be a multiplier applied to a reserved campaign, but it can be easier to describe a bid bias value as a relative value applied to bids from non-reserved campaigns. Although a bid bias value can be larger than one, a bid bias value applied to a non-reserved campaign can often have a value between 0 and 1, to reflect a reduced preference for assigning an impression to a non-reserved campaign. For example, a variety of sources of bids may be available to compete for an impression. A reserved campaign that has not met the minimum delivery constraint can be the first source. Reserved campaigns that have met the minimum delivery constraint but that are still below the maximum constraint can be a second source. A non-reserved campaign hosted by the publisher can be the third source. Optionally, multiple non-reserved campaigns may be hosted by a publisher, and each may be able to offer bids independently. An additional source of bids can be bids from any third party source. Each different type of source can have an applied bid bias that modifies the bid from that source. A bid bias still allows each bid source to offer a bid for an impression. The bid bias values can be selected to allow reserved campaigns to win a sufficient number of impressions to meet minimum delivery constraints, but other factors can also be used in determining bid bias values. Bid bias values can also be used to allow hosted non-reserved campaigns to spend an expected budget in preference to acquiring third party non-reserved advertising. Bid bias values can optionally be modified over time if a campaign is deviating from an expected win rate and/or wins over time.

Bid bias values can be values associated with a particular reserved campaign, or a type of available impression. Although bid bias values can be associated with a campaign, the bid bias values are commonly applied against any bid from a bid source. In alternative embodiments, bid bias values could be altered based on the non-reserved campaign that the bid bias value is applied against, as opposed to applying the same bid bias value to any campaign from a bid source.

The baseline bid values described, along with the modifications and/or bid bias values, can represent bid value information that is provided to one or more bidding agents based on the allocation of inventory to expected impressions. In some embodiments, conducting an auction based on such values provided to bidding agents can enhance and/or maximize the revenue a publisher receives for impressions. As described previously, one method for assigning inventory to estimated impressions can include maximizing a function that includes revenue. Thus, to the degree that the estimated impressions are representative of the actual impressions, the bid values generated based on assigning inventory to estimated impressions can correspond to bid values that enhance revenue.

Yet another option for modifying an auction can be to include a floor price for an auction. A floor price can represent a minimum bid value that must be provided by a hosted non-reserved bid and/or a third party non-reserved bid in order to win an auction for an impression. Optionally, the floor price can be compared with a bid value after application of a bid bias to the bid value. If the highest bid value in an auction (after optional application of bid bias) is less than the floor price, the impression can be assigned to a reserved bid as the winner regardless of the bid offered by the reserved campaign. Alternatively, the impression can be assigned to any bid source that does not have to meet the floor price requirement.

Still another option can be to allow a bidding agent to change the bid for a hosted campaign. The auction rules, baseline bids, and bid bias values represent off-line calculations. In an auction setting, a campaign may be performing incorrectly relative to the calculated off-line goals. The off-line values may only be calculated on a periodic basis. Rather than allowing a campaign to deviate too greatly from the campaign goals, a bidding agent can be used in an effort to meet short time goals. The bidding agent can be given boundaries within which a bid can be modified. The bidding agent can then be used to change bids in order to achieve a target win rate, a target wins per time, and/or a target average value for impressions won by a campaign. A bidding agent can typically have a constraint corresponding to a maximum bid from the bidding agent. The maximum bid can be a multiplying factor based on the modified baseline bid for a campaign, or the multiplying factor can be applied to the impression value associated with an impression.

Still another type of bid modification can be related to frequency fatigue. Some users may frequently visit the same site or the same types of sites. A campaign that successfully wins auctions may have an opportunity to present multiple advertising impressions to the same user. Over time, the value of showing additional impressions to the same user may decrease. In order to reduce or mitigate this “fatigue” by a user, the value of impressions to the fatigued user can be reduced for that campaign. Optionally, frequency fatigue modifications can be applied based on a group of related campaigns.

The auction rules and bid bias values have the potential to create a large amount of additional information that is tracked for each impression and/or each campaign. One way of simplifying the amount of additional information can be to set up page groups. A page group can represent a group of impressions, web pages, and/or advertising campaigns that share a common set of auction rules and bid bias values. Rather than having a different set of rules for each impression, a limited number of rule sets can be created. The rule sets can then be blended together using probabilities for selecting each rule set. Bid bias values can then be added to each impression and/or payload to provide a compact way of expressing a full set of rules for each item.

The following is an example of application of the above concepts in an auction setting. In this example, three rule sets will be discussed. Rule set A requires assignment of an impression to a reserved campaign. Rule set B allows for competition between reserved campaigns and hosted non-reserved campaigns. Rule set C also allows for competition with third party advertising. In this example, the available impression has probabilities for selecting rule sets A, B, and C of 0.8, 0.1, and 0.1 respectively. This indicates some excess inventory is available for this type of impression. The reserved payload selected for the impression has probabilities of 0.8, 0.2, and 0 respectively. This indicates that this payload, or the orders competing with this payload, have some risk for underdelivery. This can be due to a limited supply of inventory, or possibly due to unexpectedly high demand for the impressions served by this payload by third parties. Both impression and payload have bid bias values of 0.5 for hosted non-reserved bids and 0.2 for third party bids.

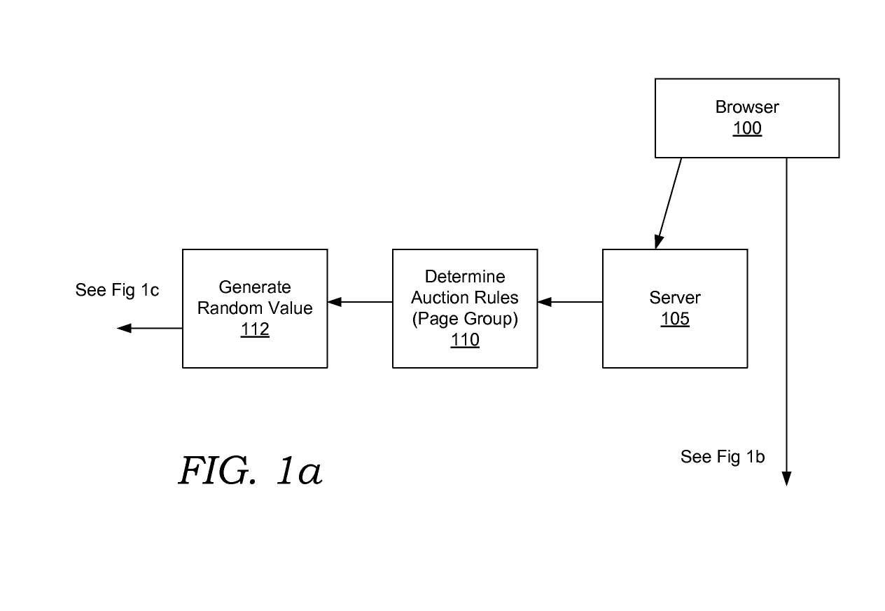

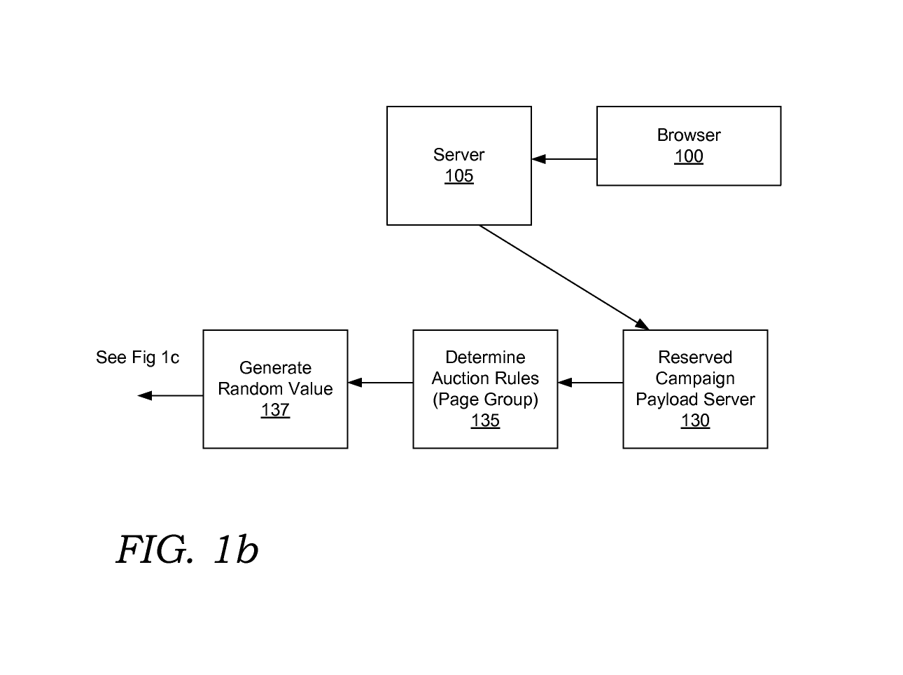

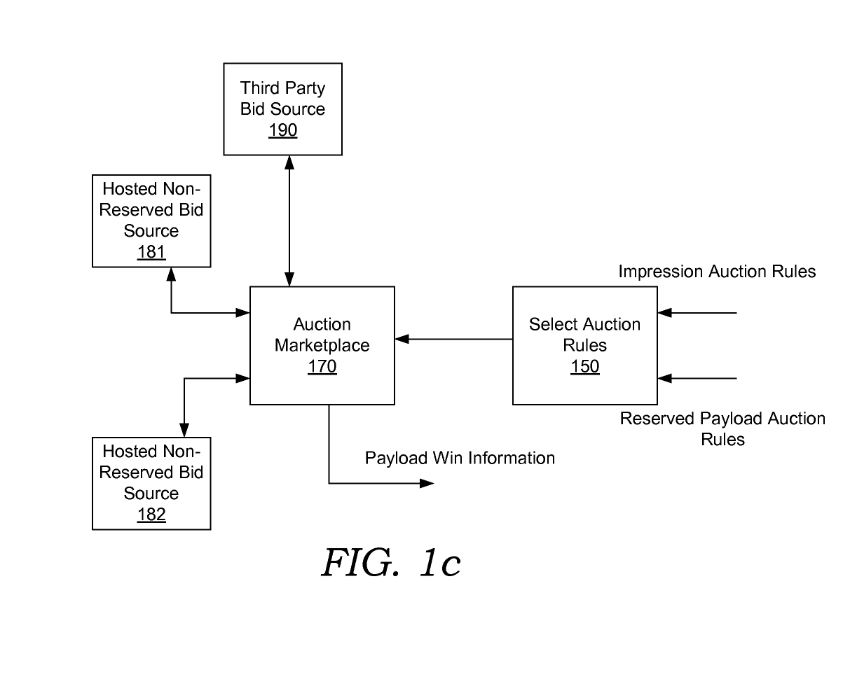

FIG. 1a schematically shows the initial steps for assigning an advertisement to an available impression based on the type of available ad impression. FIG. 1b schematically shows the initial steps for assigning an advertisement payload based on the types of reserved campaigns that are suitable for appearing in the impression location. In FIG. 1c, the outputs from the initial steps in FIGS. 1a and 1b can be used to determine the type and amount of competition, if any, from non-guaranteed campaigns for the available impression.

In FIG. 1a, a browser 100 displays a web page to a user. The web page can include a location for an advertising impression. The browser can send an ad request to a server 105 to obtain an advertising payload for display in the impression location. The ad request is forwarded by server 105 to the payload server for reserved campaigns. This will be discussed further in FIG. 1b. The ad request is also evaluated by server 105 to determine the auction rules for the ad request, such as by determining the page group 110 for the ad request. Each impression can have an associated page group 110. The page group 110 can include several types of information regarding an impression. The page group 110 can specify an auction rule set. An auction rule set can specify, for example, what types of advertisements are eligible to compete for an impression. Optionally, a page group can specify a group of auction rule sets, along with a probability of using each rule set. The page group 110 can also provide bid bias information. A bid bias can represent a weighting factor applied to one or more bids competing for an impression. The bid bias weighting factor can give preference to some types of bids to win a particular impression. For example, a bid bias can be applied to all ads that are not part of a reserved campaign. This can reflect a desire to meet the requirements of guaranteed campaigns first unless a non-guaranteed advertisement can pay a sufficient premium to the publisher.

After determining the page group 110, if there is more than one possible set of auction rules, a random number 112 can be generated to select the auction rule that will be associated with the particular impression. The auction rule set, bid biases, and optionally other information can then be forwarded for further processing, as will be discussed in FIG. 1c.

In FIG. 1b, the browser 100 forwards an ad request to the payload server 130 for guaranteed campaigns. The payload server 130 can analyze the nature of the ad request. Suitable payloads can be identified, and the bid associated with each payload can be evaluated. The determination of how a given reserved payload will bid for an impression can be determined ahead of time. For example, this can be determined based on the expected allocation of impression to reserved campaigns. Based on the bids, a payload from a reserved campaign can be selected to compete in an auction for the impression. After selecting a payload, the auction rule set and bid biases associated with the payload can be determined 135. Optionally, more than one auction rule set may be possible, and a random number can be generated 137 to determine the auction rule set that applies to the particular payload. The auction rule set, bid biases, and optionally other information can then be forwarded for further processing.

In FIG. 1c, the auction rule set and bid bias information based on both the impression and the selected guaranteed payload can be compared for selection 150. Based on the comparison, the more restrictive auction rule set can be selected. For example, if the rule set associated with the impression allows any ad campaign to bid but the selected guaranteed payload has an associated rule set that limits the allowed bidders, then the more limited rule set can be selected. After selecting 150 a rule set, the ad request, selected auction rule and corresponding bid bias values, and the reserved campaign payload information can be forwarded to an auction marketplace 170. The auction marketplace 170 can then accept bids from other advertising sources. The bids can come from other non-guaranteed ad campaigns being hosted by the same publisher, or the bids can come from third party publishers. In FIG. 1c, two separate streams 181 and 182 of non-guaranteed ad campaigns hosted by the publisher/owner of the marketplace are shown, along with a representation 190 for bids from third party ad publishers. It is noted that in some situations the auction rules may limit bidding to only reserved campaigns. In such situations, the ad request, payload, and rule set information do not need to be transferred to the auction marketplace. Instead, the ad may optionally be served directly by the payload server for the guaranteed campaigns.

The auction marketplace 170 can accept bids from bidders that are permitted under the selected auction rules. The bids can be weighted based on the corresponding bid bias values. Optionally, the auction rules can also include a price floor for bids from non-reserved campaigns. Based on the bid values, as modified by bid bias values, a winning bid can be determined. The payload corresponding to the winning bid can then be served back to the browser for delivery in the impression location.

At the end of this specification, an appendix is included containing pseudo-code corresponding to an example of an algorithm for allocating expected impressions to inventory and determining bid values.

### Auction Feedback

As auctions progress and impressions are assigned to campaigns, various types of auction information can be collected and fed back into the algorithm for assigning inventory to expected impressions. Such feedback can allow for adjustments to the probabilities for selecting auction rules for a given impression or reserved payload. Such feedback can also allow for modification of bid bias values. One type of auction data can be variations in the type of impressions being generated relative to the predicted types. If the amount and/or type of impressions being generated are deviating from the expected values, the predictions of impression amounts can be modified to better reflect the impressions that are actually occurring. This can be used to recalculate the assignment of inventory to expected impressions.

Another type of feedback can be win score information regarding the bid values, win rates, wins over time, and/or average win impression value for various campaigns. A bidding agent can perform some adjustment to bidding strategy over short periods of time to keep a campaign on track. When the next update to the auction rules and bid bias values occurs, the information from the bidding agent can be used to modify the auction rules or bid bias values for a campaign in order to better reflect the auction environment. For example, if a reserved campaign is winning too many impressions and is at risk for overdelivery, the probability of selecting an auction rule for automatic assignment to the reserved campaign can be lowered. If a hosted campaign is winning too infrequently due to unexpectedly high bids from third party bidders, the bid bias on third party bidders can be reduced so that even higher bids are required from the non-hosted bidders.

Another factor that can be addressed based on auction feedback is skimming of high value impressions by non-reserved campaigns. Reserved campaigns typically measure impression value using a baseline bid of cost per impression. By contrast, non-reserved campaigns may measure impression value based on a cost per click or a cost per action. For impressions that have a high associated click through rate, a non-reserved campaign can make a bid that reflects the high click through rate. However, impressions with high click through rates are also likely to be high value impressions. Without a measure of average value for impressions won, a campaign might achieve desired goals for number of impressions by winning only lower value impressions. Based on the average value for impressions won, the auction rules and/or bid bias values can be modified to maintain a representative sample of impressions for a campaign.

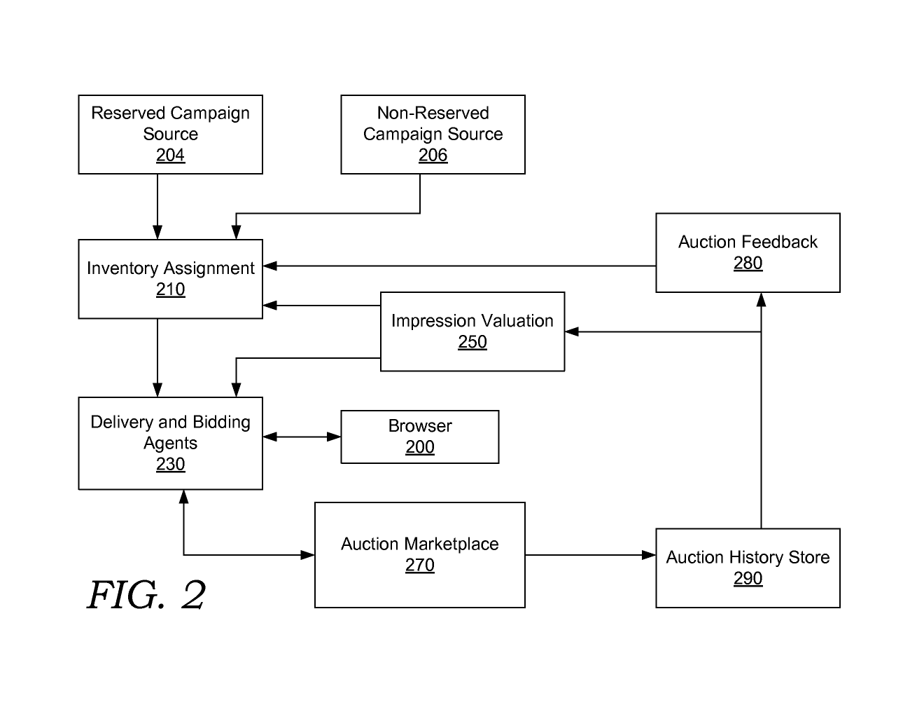

FIG. 2 provides an overview of another process flow according to an embodiment of the invention. In FIG. 2, two sources of hosted campaign inventory are shown. Hosted reserved campaign source 204 corresponds to orders with minimum delivery guarantees, while hosted non-reserved campaign source 206 corresponds to orders without a minimum delivery guarantee. The hosted campaign sources 204 and 206 contain the details of any hosted campaigns, such as the constraints for types of impressions desired by the campaigns and baseline bid values. The information regarding hosted campaigns 204 and 206 can be used by inventory assignment module 210 to assign demand from hosted campaigns to expected impressions. The assignments can be made to minimize underdelivery for hosted reserved campaigns and to minimize underspend of expected budget for hosted non-reserved campaigns. The inventory assignment can also receive input from impression valuation engine 250, which can provide valuations for the expected impressions. The valuations can be based on the profile for the expected impressions, such as profile information regarding the content of the page containing the expected impression, the expected user viewing the impression, and other factors. Inventory assignment module 210 can also receive feedback from auctions via auction feedback module 280.

Inventory assignment module 210 can use the various inputs to generate auction rules sets (including bid bias values) and expected win score information. This information can be used by delivery and bidding agents 230 to provide the parameters for conducting advertising auctions. The advertising auctions can be resolved in auction marketplace 270. When a browser 200 indicates to delivery and bidding agents 230 that an impression is available, auction rules are selected and forwarded to the auction marketplace along with one or more auction bids. After the auction is resolved, the appropriate payload can be directed back to browser 200. The statistics from the auction can also be gathered and forwarded to auction history store 290. The information can also be used as feedback for impression valuation 250 and auction feedback 280. In FIG. 2, this feedback to impression valuation 250 and auction feedback 280 is shown as being transmitted via auction history store 290, but this is optional. The feedback information can be passed directly to impression valuation 250 and auction feedback 280 if desired.

Having briefly described an overview of embodiments of the present invention and some of the features therein, an exemplary operating environment suitable for implementing the present invention is described below.

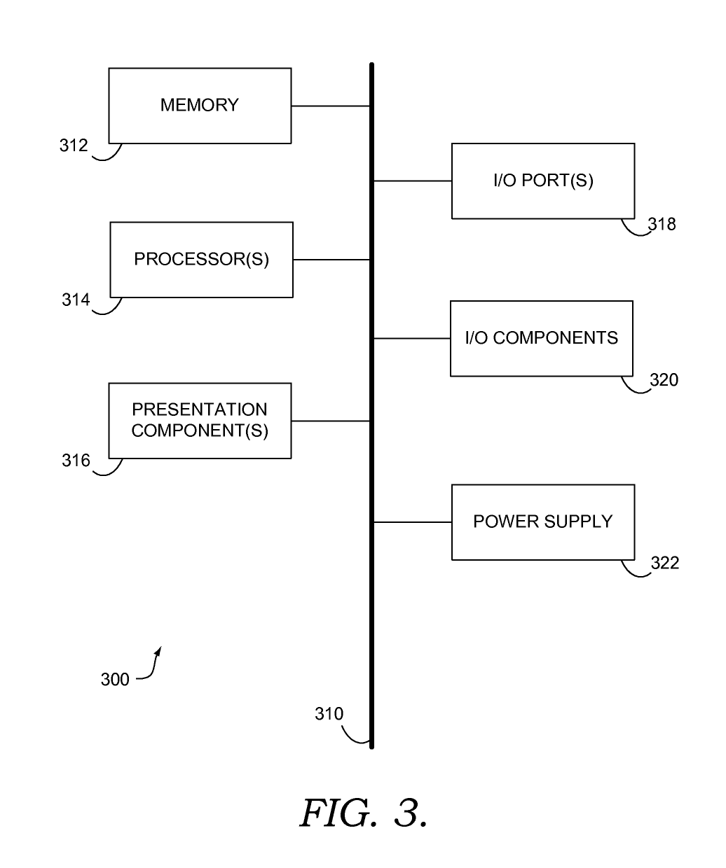

Referring to the drawings in general, and initially to FIG. 3 in particular, an exemplary operating environment for implementing embodiments of the present invention is shown and designated generally as computing device 300. Computing device 300 is but one example of a suitable computing environment and is not intended to suggest any limitation as to the scope of use or functionality of the invention. Neither should the computing device 300 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 3, computing device 300 includes a bus 310 that directly or indirectly couples the following devices: memory 312, one or more processors 314, one or more presentation components 316, input/output (I/O) ports 318, I/O components 320, and an illustrative power supply 322. Bus 310 represents what may be one or more busses (such as an address bus, data bus, or combination thereof). Although the various blocks of FIG. 3 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 3 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 3 and reference to “computer” or “computing device.”

The computing device 300 typically includes a variety of computer-readable media. Computer-readable media can be any available media that can be accessed by computing device 300 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 300. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Memory 312 includes computer-storage media in the form of volatile and/or nonvolatile memory. The memory may be removable, nonremovable, or a combination thereof. Exemplary hardware devices include solid-state memory, hard drives, optical-disc drives, etc. Computing device 300 includes one or more processors that read data from various entities such as memory 312 or I/O components 320. Presentation component(s) 316 present data indications to a user or other device. Exemplary presentation components include a display device, speaker, printing component, vibrating component, etc. I/O ports 318 allow computing device 300 to be logically coupled to other devices including I/O components 320, some of which may be built in. Illustrative components include a microphone, joystick, game pad, satellite dish, scanner, printer, wireless device, etc.

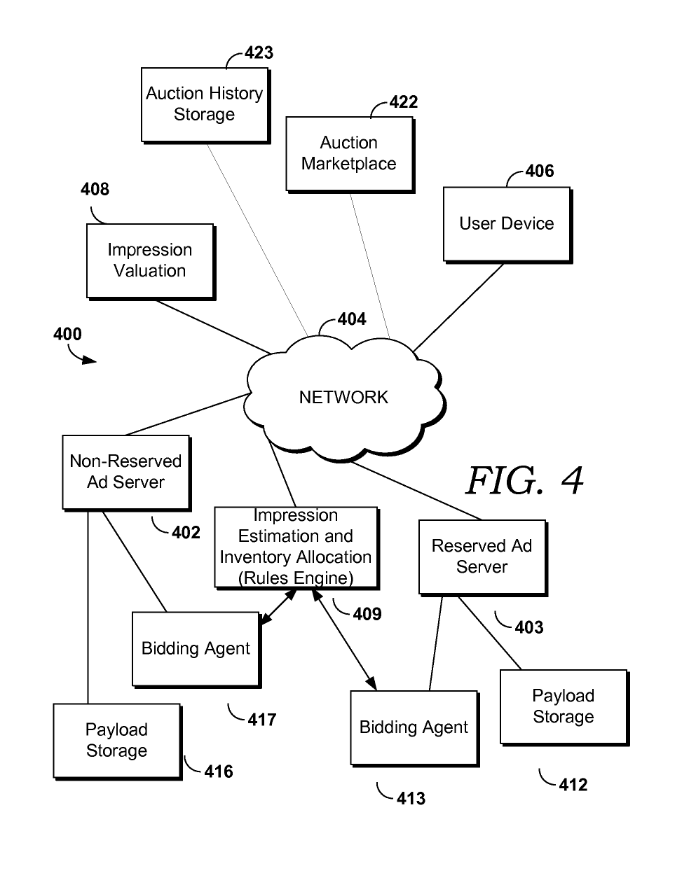

With additional reference to FIG. 4, a block diagram depicting an exemplary network environment 400 suitable for use in embodiments of the invention is described. The environment 400 is but one example of an environment that can be used in embodiments of the invention and may include any number of components in a wide variety of configurations. The description of the environment 400 provided herein is for illustrative purposes and is not intended to limit configurations of environments in which embodiments of the invention can be implemented.

The environment 400 includes a network 404, a user device 406, an auction marketplace 422, an impression valuation component 408, and an impression estimation and inventory allocation component 409. Optionally, the impression estimation and impression allocation can be performed by separate components. Optionally, the impression estimation and inventory allocation component 409 can further include a rules engine for developing auction rule sets based on an inventory allocation. The environment also includes one or more payload servers, such as reserved ad server 403 and non-reserved ad server 402. A payload server such as reserved ad server 403 can include a payload storage component 412, or payload storage can be a separate component. A bidding agent 413 is also shown as being included as part of an ad server, but the bidding agent 413 can also be a separate component. Non-reserved ad server 402 can also include a payload storage component 416 and bidding agent 417. The network 404 includes any computer network such as, for example and not limitation, the Internet, an intranet, private and public local networks, and wireless data or telephone networks. The user device 406 can be any computing device, such as the computing device 300, from which a search query can be provided. For example, the user device 406 might be a personal computer, a laptop, a server computer, a wireless phone or device, a personal digital assistant (PDA), or a digital camera, among others. In an embodiment, a plurality of user devices 406, such as thousands or millions of user devices 406, can be connected to the network 404. Similarly, other components shown in FIG. 4 can be hosted on any suitable computing device, such as the computing device 300.

In the embodiment shown in FIG. 4, a browser located on a user device 406 can display a web page that contains an available advertising impression. The browser on user device 406 can send a request to a payload server, such as reserved ad server 403, for an advertisement to place in the impression location. The reserved ad server 403 can determine if the impression request is suitable for the auction marketplace 422. This determination may be made based on, for example, information from impression estimation and allocation component 409 regarding the expected amount of inventory that is available. If it is suitable, the reserved ad server 403 can send the impression request, along with a bid from bidding agent 413, to the auction marketplace 422. The auction marketplace 422 can obtain a rule set for the auction. This can be a rule set obtained from impression valuation component 408, a rule set obtained from a payload server, or a rule set obtained from a rules engine associated with inventory allocation component 409. Based on the rule set, auction marketplace 422 can obtain bids from additional bid sources, such as a bid from the bidding agent 417 for non-reserved ad server 402. A winning bid can be determined, and a payload can be sent from a payload storage to the user device 406 to fill the impression. The results of the auction can be stored in auction history storage 423. The results can be used to provide feedback to inventory estimation 409. Based on this feedback, the estimate of inventory can be updated, possibly leading to new bidding instructions for bidding agents 413 and 417.

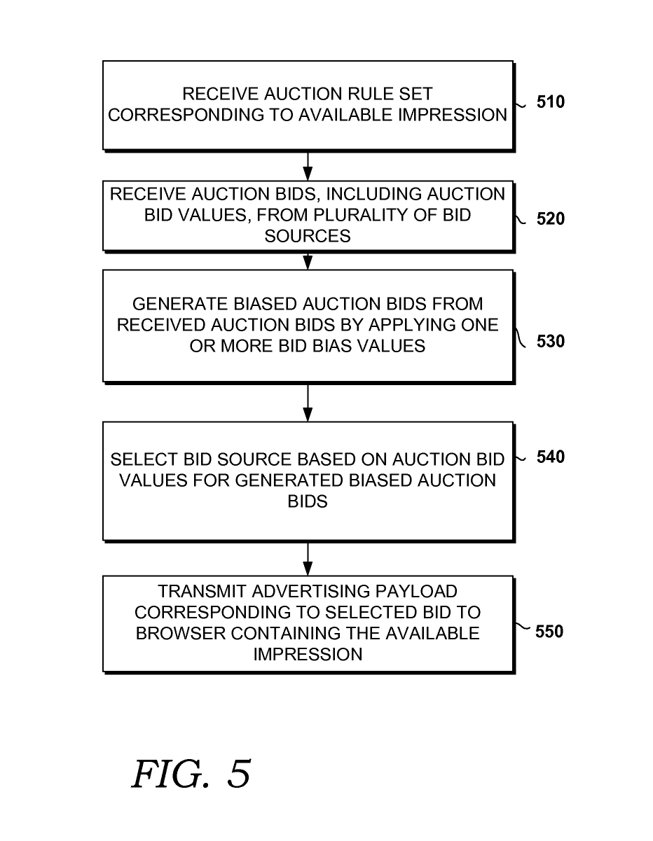

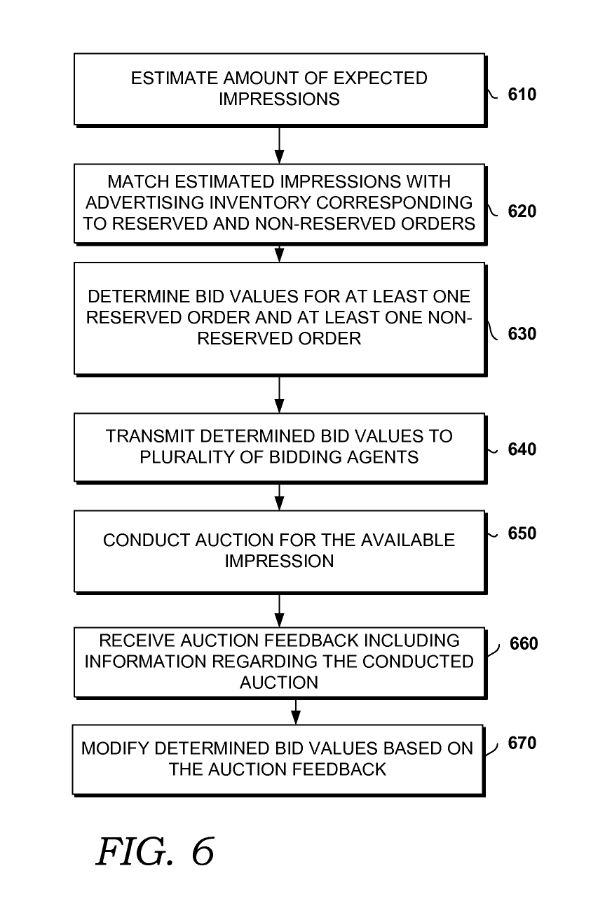

FIGS. 5-6 provide examples of additional embodiments according to the invention. In an embodiment shown in FIG. 5, a method for matching an advertising payload with an available impression is schematically shown. An auction rule set corresponding to an available impression can be received 510. The auction rule set can include an identification of a plurality of bid sources and one or more bid bias values. Auction bids can be received 520 from the plurality of bid sources. The auction bids can include auction bid values. At least one of the bid sources corresponding to a hosted reserved bid source. Biased auction bids can be generated 530 from the received auction bids by applying the one or more bid bias values to an auction bid value for at least one received auction bid. A bid source can be selected 540 based on auction bid values for the generated biased auction bids. An advertising payload can be transmitted 550 corresponding to the selected bid source to a browser containing the available impression.

In an embodiment shown in FIG. 6, a method is provided for conducting an advertising auction. The method includes estimating 610 an amount of expected impressions. The estimated impressions can include estimated amounts of impressions having various impression profiles, such as estimates of user profiles viewing an impression and page content associated with the estimated impression. Estimated impressions can be matched 620 with advertising inventory. The inventory can correspond to a plurality of hosted reserved orders and a plurality of hosted non-reserved orders. The matching 620 can be based on solution of at least one linear program, the at least one linear program including at least a first constraint related to an underdelivery of impressions and a second constraint related to underspend of a budget. Based on said matching, bid values can be determined 630 for at least one hosted reserved order and at least one hosted non-reserved order. In some embodiments, the determined bid values can correspond to bid values that enhance and/or maximize the revenue generated from an auction for an impression based on the estimate of expected impressions. The determined bid values can be transmitted 640 to a plurality of bidding agents. For example, a bidding agent can be associated with each potential bid source for submitting bids to an auction. An auction can then be conducted 650 for an available impression. The auction can receive bids from bidding agents corresponding to the at least one hosted reserved order and the at least one hosted non-reserved order. Preferably, the bids received by the auction from the bidding agents can be based on the determined bid values, although the bids received by the auction may be modified by bidding agents relative to the determined bid values. Auction feedback can be received 660 including information regarding the conducted auction. Based on the received auction feedback, the determined bid values can be modified 670.

### Additional Embodiments

In an embodiment, a computer-implemented method for matching an advertising payload with an available impression is provided. The method includes receiving an auction rule set corresponding to an available impression, the auction rule set including an identification of a plurality of bid sources and one or more bid bias values; receiving auction bids from the plurality of bid sources, the auction bids comprising auction bid values, at least one of the bid sources corresponding to a hosted reserved bid source; generating biased auction bids from the received auction bids by applying the one or more bid bias values to an auction bid value for at least one received auction bid; selecting a bid source based on auction bid values for the generated biased auction bids; and transmitting an advertising payload corresponding to the selected bid source to a browser containing the available impression.

In another embodiment, a method for setting rules for an advertising auction is provided. The method includes identifying a plurality of hosted reserved orders for advertising impressions and a plurality of hosted non-reserved orders for advertising impressions; estimating an amount of expected impressions; matching estimated impressions with advertising inventory corresponding to the plurality of hosted reserved orders and the plurality of hosted non-reserved orders, the matching being based on solution of one or more linear programs, the one or more linear programs including at least a first constraint related to an underdelivery of impressions and a second constraint related to underspend of a budget; determining, based on said matching, one or more impression win scores for at least one hosted reserved order and at least one hosted non-reserved order, at least one of the one or more impression win scores corresponding to an impression win rate, a number of impression wins per time, or an average impression value per win; calculating, based on said matching, auction rule set probabilities for the at least one hosted reserved order; calculating, based on said matching, bid bias values for the at least one hosted non-reserved order; associating the calculated auction rule set probabilities and the bid bias values with the at least one hosted reserved order; transmitting the one or more impression win scores to at least one auction bidding agent; receiving feedback from the at least one auction bidding agent regarding the one or more impression win scores, the feedback comprising auction bid values used to match the one or more impression win scores, a deviation from the one or more impression win scores, or a combination thereof; and modifying, based on the received feedback, at least one of the calculated auction rule set probabilities or the calculated bid bias values.

In still another embodiment, a method for setting rules for an advertising auction is provided. The method includes receiving a request from a browser for an advertising payload based on an available advertising impression; identifying a first auction rule set based on the available advertising impression, the first auction rule set including a plurality of rule set selection probabilities associated with the available advertising impression; determining a hosted reserved advertising payload corresponding to the available advertising impression; identifying a second auction rule set based on the determined advertising payload, the second auction rule set including a plurality of rule set selection probabilities associated with the determined advertising payload; selecting the first auction rule set or the second auction rule set, the selected auction rule set including an identification of one or more bid sources for an advertising auction and a bid bias value for at least one of the one or more bid sources; and forwarding an auction bid for the determined advertising payload and the selected auction rule set to an auction marketplace

In yet another embodiment, a method is provided for conducting an advertising auction, comprising: estimating an amount of expected impressions; matching estimated impressions with advertising inventory corresponding to a plurality of hosted reserved orders and a plurality of hosted non-reserved orders, the matching being based on solution of at least one linear program, the at least one linear program including at least a first constraint related to an underdelivery of impressions and a second constraint related to underspend of a budget; determining, based on said matching, bid values for at least one hosted reserved order and at least one hosted non-reserved order; transmitting the determined bid values to a plurality of bidding agents; conducting an auction for an available impression, the auction receiving bids from bidding agents corresponding to the at least one hosted reserved order and the at least one hosted non-reserved order, the bids received by the auction from the bidding agents being based on the determined bid values; receiving auction feedback including information regarding the conducted auction; and modifying, based on the received auction feedback, the determined bid value.

In still another embodiment, a system is provided for matching advertising payloads to available impressions, comprising: an impression estimation component for estimating an amount of impressions that can be assigned; an inventory allocation component configured to allocate inventory to estimated impressions; a plurality of bidding agents configured to submit bids for available impressions, the bids being based on the inventory allocation; an auction marketplace for conducting an advertising auction to assign available impressions to inventory based on bids from the plurality of bidding agents; at least one payload server for delivering an advertising payload based on an assignment of an available impression; and an auction feedback component configured to provide auction history information to the inventory allocation component.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

The following three tables, referred to as Algorithm 1-3, provide pseudo code for a computer program implementing portions of an embodiment of the invention.

```
Algorithm 1 GGSA - page 1
  1: function [x¹,p¹] = GGSA(x⁰, p⁰, γ, S)
  2: Inputs :
```

| 3: | x⁰ - desirable impression goal |
|---|---|
| 4: | p⁰ - suggested price // x⁰p⁰ is the budget |
| 5: | γ - geometric average parameter (to mix budget & impression |
| | count) |
| 6: | S - impression (ad request) stream |

7: Outputs :

| | |
|---|---|
| 8: | x¹ - actual impressions delivered |
| 9: | p¹ - actual average price |

10: Variables :

| | |
|---|---|
| 11: | Gᵣ, Pᵣ - delivery goal and time remained after r-micro-cycle |
| 12: | // All variables below are per r-micro-cycle |
| 13: | xᵣ, x_{q,r} - counts of delivered / qualified impressions |
| 14: | bᵣ, b_{q,r} - budget spent / qualified |
| 15: | gᵣ, g_{q,r} - goal delivered / qualified |
| 16: | rᵣ, r_{q,r}, r_{i,r} - actual / qualified / ideal goal delivery rates |
| 17: | Eᵣ - cumulative error |
| 18: | fᵣ - targeted fraction of qualified goal |
| 19: | pᵣ - (average) bid price |

20:

| | |
|---|---|
| 21: | // Initialize: |
| 22: | // Goal below is geo average of budget and impression volume |
| 23: | // γ = 0 corresponds to pure impressions: γ = 1 - to pure budget |
| 24: | Δ = 5 // we have m micro-cycles of lengths Δ |
| 25: | m = 3600/Δ |
| 26: | G₀ = (x⁰p⁰)^{γ}(x⁰)^{1-γ} |
| 27: | p₁ = p^{O} |
| 28: | ν = 0.2 · (AveragePrice) (or something like this) |
| 29: | for r = 1 : m do |

| | |
|---|---|
| 30: | xᵣ = x_{q,r} = 0 |
| 31: | bᵣ = b_{q,r} = 0 |
| 32: | for all ad request s = Get(S) within r micro-cycle do |

| | |
|---|---|
| 33: | if impression s is not qualified then |

| | |
|---|---|
| 34: | continue |

| 35: | end if |
|---|---|
| 36: | // Now we determine a price bid B. It depends on |
| 37: | // relative impression value (extra or discount |
| | multiplier |
| 38: | // for smoothness, representative allocation, BT score). |
| 39: | // It is also subject to random deviate |
| 40: | v = val(s) |
| 41: | draw η ~ N (0,1) //randomization can happen outside |
| 42: | B = pᵣ · v + νη. |
| 43: | B⁰ = GetFloorPrice(s) |
| 44: | if B < B⁰ then |

| | |
|---|---|
| 45: | B = B⁰; |
| 46: | if rᵣ₋₁ > r [symbol] _{,r-1} then |

| 47: | draw a uniform ra [symbol] dom number 0 ≦ |
|---|---|
| | θ ≦ 1 |
| 48: | if θ > r_{i,r-1}/rᵣ₋₁ then |

| | |
|---|---|
| 49: | continue // this is called throttling |

| | |
|---|---|
| 50: | end if |

| | |
|---|---|
| 51: | end if |

| | |
|---|---|
| 52: | end if |
| 53: | if B violates priority bounds then |

| | |
|---|---|
| 54: | Cap B // |

| | |
|---|---|
| 55: | end if |

[symbol]

indicates data missing or illegible when filed

Algorithm 2 GGSA - page 2

| 56: | // Concurrently with other campaigns, bid on s with |
|---|---|
| | price B |
| 57: | // win = 1/0 if impression is won/lost |
| 58: | // q(s) is actual price paid by a winning campaign |
| 59: | [won, q(s)] = Bid(s, B) |
| 60: | x_{q,τ} = x_{q,τ} + 1 |
| 61: | b_{q,τ} = b_{q,τ} + q(s) |
| 62: | if won = 1 then |

| | |
|---|---|
| 63: | x_{τ} = x_{τ} + 1 |
| 64: | b_{τ} = b_{τ} + q(s) |

| | |
|---|---|
| 65: | end if |

| 66: | end for// τ-micro-cycle is over | |
|---|---|---|
| 67: | // Following updates assume one server. Optionally, several | |
| 68: | // distributed servers can be synced up from time to time | |
| 69: | g_{τ} = b_{τ}^{γ},r_{τ}^{1-γ} | |
| 70: | g_{q,τ} = b_{q,τ}^{γ}x_{q,τ}^{1-γ} | |
| 71: | G_{τ} = G_{τ-1} − g_{τ} | |
| 72: | P_{τ} = (m − τ)Δ | |
| 73: | r_{τ} = g_{τ}/Δ | |
| 74: | r_{q,τ} = g_{q,τ}/Δ | |
| 75: | r_{i,τ} = G_{τ}/P_{τ} | |
| 76: | // Smooth variables r_{τ}, r_{q,τ} through exponential averaging | |
| | into | |
| 77: | // similar variables R_{τ}, R_{q,τ}. Here 0 < z < 1 is a parameter, | |
| 78: | // For the first τ = 1, use z = 0 | |
| 79: | R_{τ} = zR_{τ-1} + (1 − z)r_{τ} | |
| 80: | R_{q,τ} = zR_{q,τ-1} + (1 − z)r_{q,τ} | |
| 81: | // | Various forms of cumulative error (we may or |

| 82: | // may not need it - to keep flexibility see coefficient 0 ≦ |
|---|---|
| | z₁ < 1 |
| 83: | // below). Simples version is: E_{τ} = zE_{τ-1} + (1 − z)(1 − |
| | R_{τ}/r [symbol] _{,τ}) |
| 84: | E_{τ} = Err(E_{τ-1},R_{τ},r_{i,τ}) |
| 85: | // Compute ideal goal fraction f_{τ} and next bid p_{τ+1} |
| 86: | // Below 0 ≦ F(x) ≦ 1 is monotonically increasing |
| 87: | // F(x) → 0 for x → −∞. F(x) → 1 for x → ∞ |
| 88: | // Example: F(x) = (x < 0)?(x > 1)?1 : x |
| 89: | f_{τ} = F(r [symbol] _{,τ}/R_{q,τ} + z₁E_{τ}) |
| 90: | // |
| 91: | // Now we are ready to determine next micro-cycle base |
| | price |
| 92: | (subject to random deviates) |
| 93: | p_{τ+1} = Update(p_{τ}, f_{τ}, f_{τ-1}) |

| | |
|---|---|
| 94: | end for |
| 95: | x¹ = Σ_{τ=1:m} x_{τ} // impressions actually delivered |
| 96: | b¹ = Σ_{τ=1:m} b_{τ} // budget actually delivered |
| 97: | p¹ = b¹/x¹ // average price paid |
| 98: | return x¹,p¹ |

99: end function [symbol]
indicates data missing or illegible when filed

Algorithm 3 Update
1: function pᵣ₊₁ = UPDATE(pᵣ, fᵣ, fᵣ₋₁)

| | |
|---|---|
| 2: | There are two ways to implement this function: |
| 3: | 1. Pretend that price distribution is Normal |
| 4: | |
| 5: | Normal distribution has two parameters μ and σ |
| 6: | They can be computed from two sufficient statistics |
| 7: | m₁ = Σ [symbol] q(s),m₂ = Σₛ q(s)2 |
| 8: | Then pᵣ₊₁ is determined so that the fraction of |
| 9: | the partial moment to the left of it is equal to fᵣ |
| 10: | (see full text p.24) |

11:

| 12: | 2. Apply optimal control considerations |
|---|---|
| 13: | |
| 14: | For example: |
| 15: | Divide price range into small intervals π₁, ....,π_{K} |
| 16: | π₁ - is floor price, π_{K} - max price |
| 17: | Accumulate stats of what fraction of g within [πₖ, πₖ₊₁] price |
| | range, |
| 18: | within price range assume liner (or any curve fitting) profile |
| 19: | Let f(p) be this profile (updated during each mycro-cycle |
| 20: | Return pᵣ₊₁ = f⁻¹(fᵣ + α(fᵣ − fᵣ₋₁)) |

21: end function [symbol]
indicates data missing or illegible when filed

What is claimed is:

1. A computer-implemented method for matching an advertising payload with an available impression, comprising:
receiving an auction rule set corresponding to an available impression, the auction rule set including an identification of a plurality of bid sources and one or more bid bias values;
receiving auction bids from the plurality of bid sources, the auction bids comprising auction bid values, at least one of the bid sources corresponding to a hosted reserved bid source;
generating biased auction bids from the received auction bids by applying the one or more bid bias values to an auction bid value for at least one received auction bid;
selecting a bid source based on auction bid values for the generated biased auction bids; and
transmitting an advertising payload corresponding to the selected bid source to a browser containing the available impression.

2. The method of claim 1, wherein generating the biased auction bids comprises applying the one or more bid bias values to auction bid values for a subset of the received auction bids.

3. The method of claim 2, wherein selecting a bid source based on auction bid values comprises selecting a biased auction bid that was not modified by application of a bid bias value.

4. The method of claim 1, wherein receiving auction bids from a plurality of bid sources further comprises receiving a floor price value.

5. The method of claim 4, wherein selecting a bid source based on bid values comprises
determining that the floor price value is greater than the auction bid values for the generated biased auction bids; and
selecting the hosted reserved bid source.

6. The method of claim 1, wherein receiving an auction rule set comprises:
receiving a plurality of auction rule sets with associated probabilities;
selecting an auction rule set from the plurality of received auction rule sets by comparing a random value with the associated probabilities.

7. One or more computer-storage media storing computer-useable instructions that, when executed by a computing device, perform a method for conducting an advertising auction, comprising:
estimating an amount of expected impressions;
matching estimated impressions with advertising inventory corresponding to a plurality of hosted reserved orders and a plurality of hosted non-reserved orders, the matching being based on solution of at least one linear program, the at least one linear program including at least a first constraint related to an underdelivery of impressions and a second constraint related to underspend of a budget;
determining, based on said matching, bid values for at least one hosted reserved order and at least one hosted non-reserved order;
transmitting the determined bid values to a plurality of bidding agents;
conducting an auction for an available impression, the auction receiving bids from bidding agents corresponding to the at least one hosted reserved order and the at least one hosted non-reserved order, the bids received by the auction from the bidding agents being based on the determined bid values;
receiving auction feedback including information regarding the conducted auction; and
modifying, based on the received auction feedback, the determined bid values.

8. The computer-storage media of claim 7, further comprising determining auction rule set probabilities based on the matching of estimated impressions with advertising inventory.

9. The computer-storage media of claim 7, further comprising determining bid bias values based on the matching of estimated impressions with advertising inventory.

10. The computer-storage media of claim 7, wherein the hosted reserved order comprises advertising inventory valued based on impressions and the hosted non-reserved order comprises advertising inventory valued based on user interaction with impressions.

11. The computer-storage media of claim 7, wherein the conducted auction further comprises bids received from third party bid sources.

12. The computer-storage media of claim 7, wherein receiving auction feedback comprises receiving auction bid values from a bidding agent different from the determined bid values associated with the bidding agent.

13. The computer-storage media of claim 7, wherein the determined bid values are generated based on a dual of the at least one linear program.

14. A system for matching advertising payloads to available impressions, comprising:
an impression estimation component for estimating an amount of impressions that can be assigned;
an inventory allocation component configured to allocate inventory to estimated impressions;
a plurality of bidding agents configured to submit bids for available impressions, the bids being based on the inventory allocation;
an auction marketplace for conducting an advertising auction to assign available impressions to inventory based on bids from the plurality of bidding agents;
at least one payload server for delivering an advertising payload based on an assignment of an available impression; and
an auction feedback component configured to provide auction history information to the inventory allocation component.

15. The system of claim 14, the inventory allocation component further comprising a rules engine for assigning auction rules based on an allocation of inventory.

16. The system of claim 15, wherein the rules engine is configured to assign rule set probabilities and bid bias values.

17. The system of claim 14, wherein the auction marketplace is configured to receive bids from hosted bid sources and non-hosted bid sources.

18. The system of claim 14, wherein the inventory allocation component further provides at least one win score to the bidding agents.

19. The system of claim 14, further comprising an impression valuation component configured to provide valuations for available impressions.

20. The system of claim 14, wherein each bidding agent is associated with a hosted bid source.
